(19) United States
(12) Patent Application Publication
(10) Pub. No.: US 2018/0260448 A1
(43) Pub. Date: Sep. 13, 2018

(54) ELECTRONIC ENTITY CHARACTERISTICS MIRRORING

(71) Applicant: Microsoft Technology Licensing, LLC, Redmond, WA (US)

(72) Inventors: Neal Osotio, Sammamish, WA (US); Emma Williams, Medina, WA (US)

(73) Assignee: Microsoft Technology Licensing, LLC, Redmond, WA (US)

(21) Appl. No.: 15/455,312

(22) Filed: Mar. 10, 2017

(51) Int. Cl. G06F 17/30; G06F 3/14

(52) U.S. Cl. CPC G06F 17/30528; G06F 17/30958; G06F 17/3056; G06F 3/14

(57) ABSTRACT

Generating an electronic entity display that mirrors user-related characteristics based on a user's context is provided. Information associated with the user is collected and stored in a relational graph database. The collected data and other available information are used to define and infer relationships between the user and other entities and to infer characteristics associated with the user. One or more sensors are used to detect the user's context, which is utilized in determining characteristics that can be mirrored to proactively mitigate certain behaviors or reactively neutralize or redirect certain behaviors. Further, the user-related characteristics are applied to the electronic entity such that the electronic entity mirrors certain characteristics of the user for increasing user engagement with an AI system, increasing connection with the AI system, and increasing the user's trust with the electronic entity and AI system.

### BACKGROUND

Artificial Intelligence (AI) technology is becoming increasingly popular and prevalent in today's digital world. For example, AI technology utilizes machine-learning algorithms that enable systems to collect and organize massive amounts of information to make predictions and insights that are beyond the capabilities of manual processing. Further, systems that implement AI technology are able to continually learn from the data they collect. The more data there are to collect and analyze, the better the machine becomes at making predictions and insights. While some users may be comfortable with interacting with AI technology, other users may be apprehensive and distrustful. As can be appreciated, a user may not be willing to utilize AI technology, and thus may not be able to enjoy benefits provided by AI technology if the user does not feel comfortable interacting with it. The user may need to be introduced to experiences with AI technology gradually in order to feel more connected or to build trust with using AI technology.

Users oftentimes interact with an AI system via a virtual assistant or electronic entity. When utilizing a visual display, such as a screen or a virtual screen (e.g., holographic overlays via a headset), the electronic entity may be presented to the user as a two-dimensional or a three-dimensional graphical or virtual representation of an entity. If interaction with the electronic entity does not feel natural to the user, the user may feel disconnected with the entity, and interaction may be limited and unwanted.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

Aspects are directed to an automated system, method, and computer readable storage device for generating an electronic entity display that mirrors user-related characteristics based on a user's context. According to aspects, mirroring is a behavior in which one entity imitates gestures, speech patterns, or attitudes of another entity. Mirroring frequently occurs in social situations, and is oftentimes an unconscious behavior that signals to one entity that the other entity is attuned or in sync. For example, mirroring can be associated with a form of perspective-taking or empathy that shows a willingness to understand someone and connect with the person. By employing aspects of the present disclosure, an improved user experience is provided, where an electronic entity mirrors characteristics related to the user for increasing the user's trust, engagement, and connection with the electronic entity.

According to aspects, as a user interacts with content and other individuals, signals are created, collected and analyzed. These signals, in addition to other available information, can be used to define and infer relationships between the user and other entities and to infer characteristics associated with the user. Further, with the use of sensors, the user's context can be detected. For example, information about the user, the user's environment, and the user's tasks can be detected and utilized in determining characteristics to apply to an electronic entity for interacting with the user. In one example, an electronic entity mirroring system determines user-related characteristics that can be mirrored to proactively mitigate certain behaviors or reactively neutralize or redirect certain behaviors. Further, the electronic entity mirroring system applies the user-related characteristics to an electronic entity such that the electronic entity mirrors certain characteristics of the user for increasing user engagement with an AI system, increasing connection with the AI system, and increasing the user's trust with the electronic entity and AI system.

By improving the user experience and increasing user engagement with the AI system, the user is enabled to work more efficiently and the user's quality of life may be improved. Further increased engagement with the AI system allows for additional data can be collected and used to make predictions and insights that are beyond the capabilities of manual processing, and the functionality of the computing device used to provide the electronic entity mirroring system is thereby expanded and improved.

Examples are implemented as a computer process, a computing system, or as an article of manufacture such as a device, computer program product, or computer readable medium. According to an aspect, the computer program product is a computer storage medium readable by a computer system and encoding a computer program of instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a block diagram showing an example operating environment including components of an electronic entity mirroring system for generating an electronic entity display that mirrors user-related characteristics based on a user's context;

FIG. 2A shows an example storyboard that shows an example use case utilizing aspects of the electronic entity mirroring system;

FIG. 2B shows another example storyboard that shows an example use case utilizing aspects of the electronic entity mirroring system;

FIG. 3 is a flow chart showing general stages involved in an example method for generating an electronic entity display that mirrors user-related characteristics based on a user's context;

FIG. 4 is a block diagram illustrating example physical components of a computing device;

FIGS. 5A and 5B are block diagrams of a mobile computing device; and

FIG. 6 is a block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

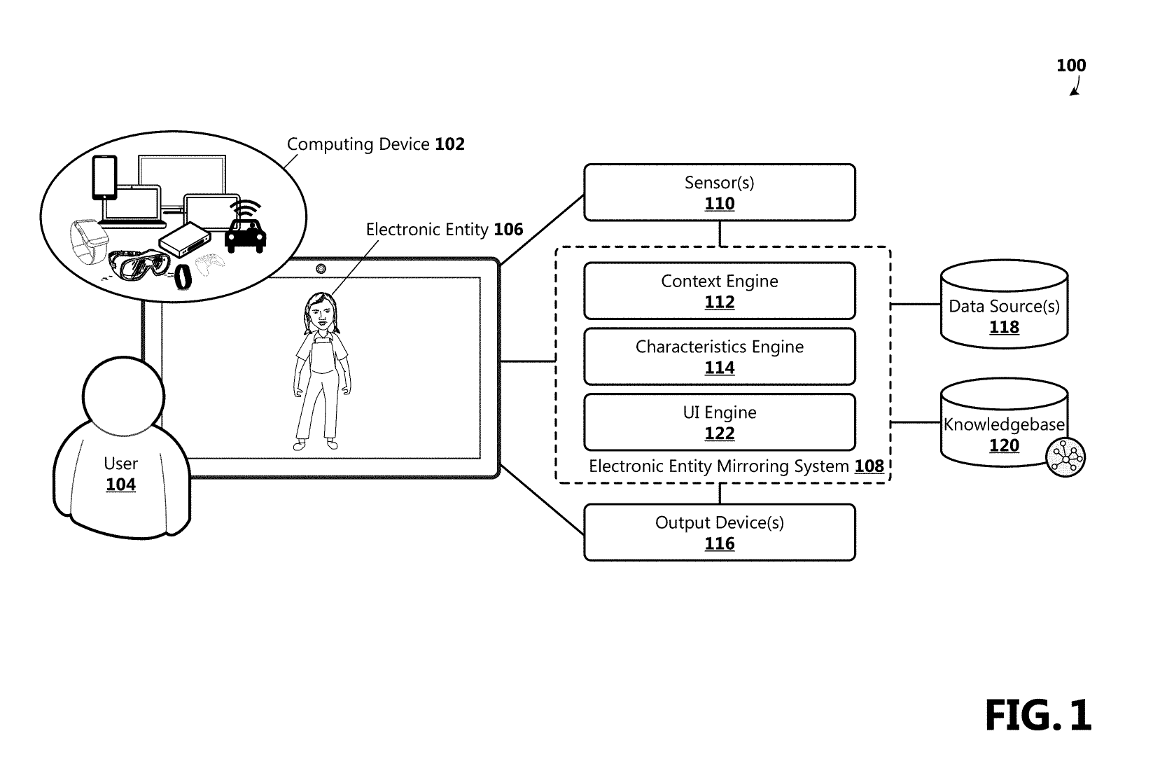

Aspects of the present disclosure are directed to a method, system, and computer storage medium for generating an electronic entity display that mirrors user-related characteristics based on a user's or users' context. With reference now to FIG. 1, a block diagram of an example operating environment 100 illustrating aspects of an example electronic entity mirroring system 108 is shown. The electronic entity mirroring system 108 is operative to provide an improved user experience and to increase user engagement with an AI system via which one or more users 104 are enabled to efficiently and effectively interact.

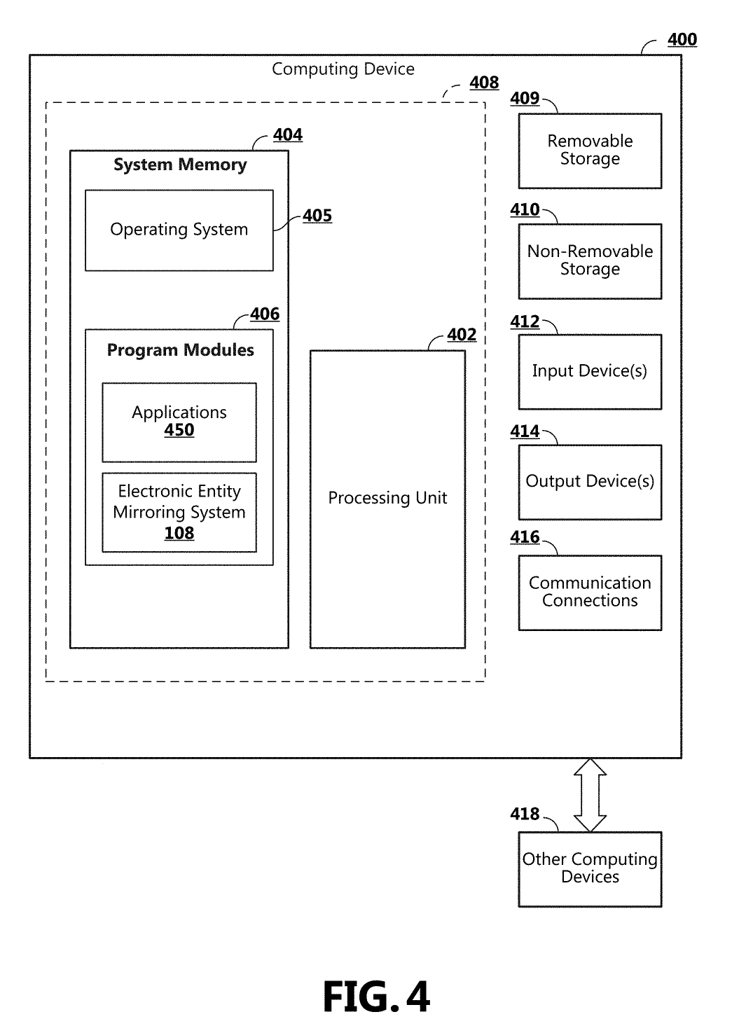

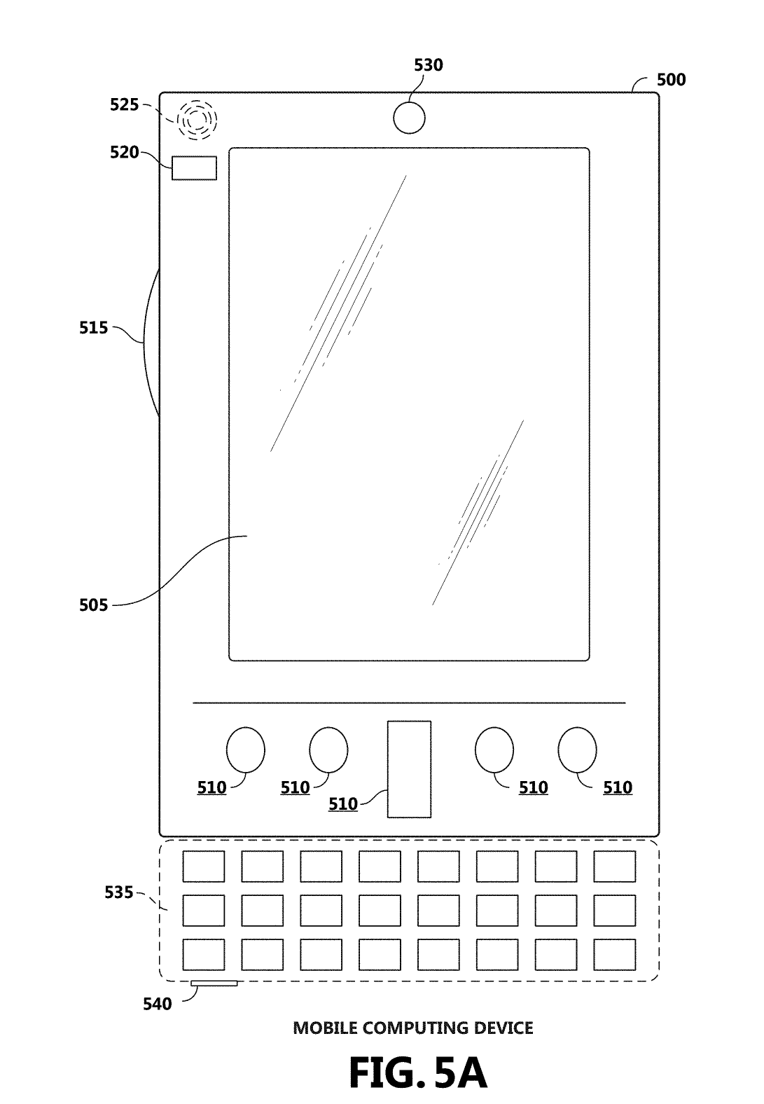

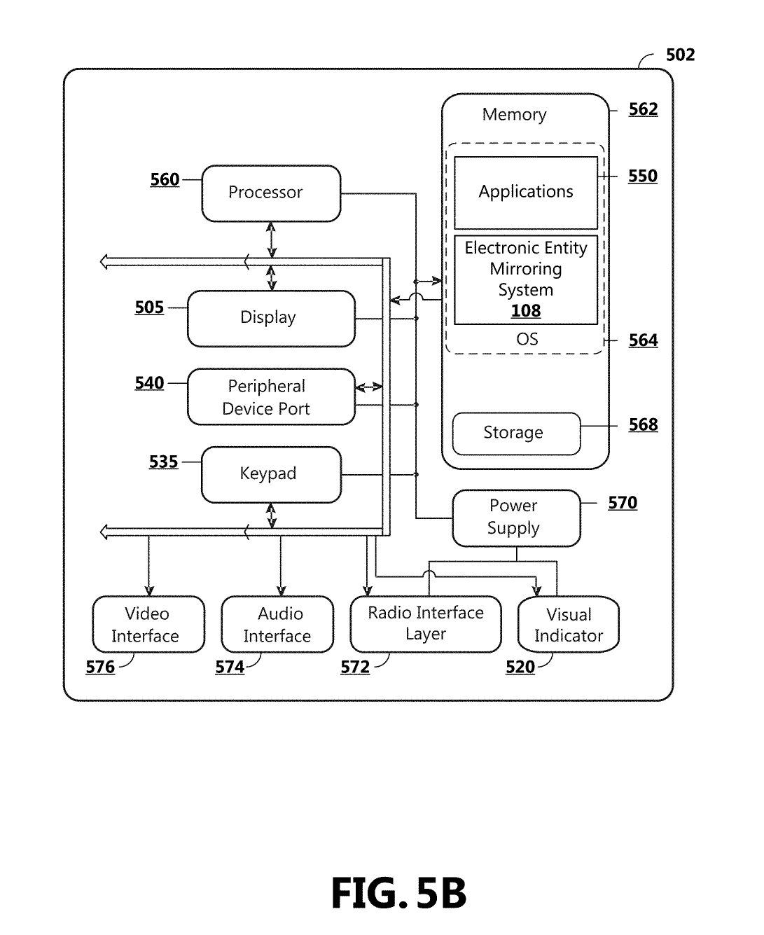

The example operating environment 100 includes an electronic computing device 102. The computing device 102 illustrated in FIG. 1 is illustrated as a tablet computing device; however, as should be appreciated, the computing device 102 may be one of various types of computing devices (e.g., a tablet computing device, a desktop computer, a mobile communication device, a laptop computer, a laptop/tablet hybrid computing device, a head-mounted display device, a large screen multi-touch display, a gaming device, a smart television, a wearable device, or other type of computing device). A user 104 may use the computing device 102 for executing applications for performing a variety of tasks, which may include, for example, to write, calculate, draw, take and organize notes, organize, prepare presentations, send and receive electronic mail, make music, and the like. The hardware of these computing devices is discussed in greater detail in regard to FIGS. 4, 5A, 5B, and 5.

According to aspects, the computing device 102 comprises or is in communication with an electronic entity mirroring system 108, illustrative of a software module, system, or device operative to generate an electronic entity 106 display that mirrors user-related characteristics based on the user's context. The electronic entity mirroring system 108 includes a context engine 112 and a characteristics engine 114.

According to an aspect, the context engine 112 is illustrative of a software module, system, or device operative to infer characteristics related to the one or more users 104. For example, the context engine 112 is operatively connected to a knowledgebase 120 that includes information about the user 104. In one example, the knowledgebase 120 includes one or more semantic graph databases used to represent entities as nodes, and attributes and relationships between the nodes as edges, thus providing a structured schematic of entities and their properties. According to examples, edges between nodes can represent an explicit relationship or an inferred relationship.

As the user 104 interacts with content or with other individuals, signals are created and collected in the one or more semantic graph databases. For example, information associated with documents that the user 104 creates or receives, organizational relationships, Internet search activities, tasks, communications, use of applications, etc., are collected and analyzed. Alone or in combination with other information, such as historical data (e.g., based on past user interactions with the electronic entity mirroring system 108), world knowledge available via one or more data sources 118, the knowledgebase 120 data can be used to define and infer relationships between the user 104 and other entities and to infer characteristics associated with the user 104. For example and without limitation, characteristics associated with the user 104 may include such characteristics as age, educational background, language and culture, computing skills, physical abilities or disabilities, job experience and competence, place in an organizational hierarchy, attitudes, motivations, frustrations relating to certain tasks or activities, general sources of stress or anxiety, and the like.

According to an aspect, the context engine 112 is further operative to utilize context data collected by one or more sensors 110 to characterize the situation of the user 104. The one or more sensors 110 can include visual sensors, audio sensors, motion sensors, biometric sensors, location sensors, or other sensors that are integrated with the computing device 102 or are in communication with the computing device 102 for acquiring contextual data. The context engine 112 is operative to abstract and understand the context data, for example, by matching a perceived sensory stimulus to a context. In some examples, the context engine 112 can determine environmental physical conditions (e.g., noise level, light level, air quality), an emotive state of the user 104 (e.g., via facial emotion detection, sentiment analysis, eye tracking), biophysiologic abnormalities (e.g., blood pressure, heartrate, temperature), the user's location, the user's activity level, and the like. In some examples, the context engine 112 is operative to determine user behaviors or patterns based in part on one or more of: context data, inferred user-related characteristics, historical data, and world knowledge data. According to some examples, the context engine 112 is further operative to provide an alert for notifying the user 104 or another individual (e.g., a parent, a teacher, a doctor) when the user's context is outside of a predetermined normal range (e.g., elevated blood pressure, increased heartrate, poor air quality, high noise level).

According to an aspect, the characteristics engine 114 is illustrative of a software module, system, or device operative to analyze the acquired context data in view of the user-related characteristics for determining a set of characteristics to apply to an electronic entity 106 for presentation and interaction with the user 104. In some examples, the characteristics engine 114 is automatically triggered when the user's context is determined to be outside of a predetermined normal range. In other examples, the characteristics engine 114 is activated in response to user-actuation.

For example, the electronic entity 106 is an electronic virtual interactive entity that is incorporated into the computing device 102 or an application executing on the computing device 102 that is configured to interface with the user 104 in a human manner. For example, the electronic entity 106 may be operative to answer user queries and perform certain tasks on behalf of the user 104, such as create reminders or events, set alarms or timers, call, text, or email people, make reservations, launch applications, find content, perform calculations, access and change settings, provide mapping information, take notes, read content, etc. According to an aspect, the electronic entity 106 is presented to the user 104 via one or more output devices 116. For example, the electronic entity 106 may be visually represented to the user 104 as an image or holographic image displayed on a display screen or virtual screen. According to an aspect, the output of the electronic entity mirroring system 108 is based in part on the device(s) being used or around the user 104. Additionally, the electronic entity 106 may be audibly represented to the user 104 as a humanoid voice provided through speakers or a headset. In some examples, the visual representation of the electronic entity 106 is an avatar or animated character.

Aspects of the electronic entity mirroring system 108 generate and provide a graphical user interface (GUI) that allows the user 104 to interact with functionality of the electronic entity mirroring system 108. According to examples, the electronic entity mirroring system 108 comprises a UI engine 122, illustrative of a software module, system, or device operative to generate a UI display including a display of the electronic entity 106 having the selected characteristics.

In some examples, in determining the set of characteristics to apply to the electronic entity 106, the characteristics engine 114 is operative to select characteristics for proactively mitigating certain user behaviors or emotive states. For example, based on various factors acquired via one or more sensors 110 and based on explicit or inferred characteristics data associated with the user 104, the context engine 112 may make a determination that the user 104 is a child who is afraid of the dark, that the child is in a dark environment, and that the child is scared. Further, the characteristics engine 114 may utilize these data to select certain characteristics to apply to an electronic entity 106 for helping to alleviate the child's fear. For example, based on information in the knowledgebase 120, the characteristics engine 114 may select an animated character that the child is fond of (e.g., a character in a show that the user 104 frequently watches, a character in a game that the user plays), and may apply a soothing voice to the entity. The electronic entity 106 having the selected characteristics may be presented to the user 104, for example, displayed on a screen of the computing device 102.

As another example, an electronic entity 106 can be utilized within the context of a collaborative group dynamic, for example, as a facilitator of a virtual meeting. Based on various factors acquired via one or more sensors 110 and based on explicit or inferred characteristics data associated with the group of users 104, the characteristics applied to the electronic entity 106 may mirror characteristics of the group to help improve efficiency. Further, based on information in the knowledgebase 120, the characteristics engine 114 may apply certain characteristics to the electronic entity 106 to present to the users 104 for proactively mitigating certain user behaviors or emotive states. For example, if a level of frustration is detected in the productivity scenario that meets or exceeds a predetermined frustration level, the audio output of the electronic entity 106 may be in a calming tone. Additionally or alternatively, certain characteristics associated with psychological-based techniques can be applied to the electronic entity 106 to help to de-escalate emotions or to help motivate the users 104.

According to an aspect, the user 104 is enabled to interact with the electronic entity 106 via one or more sensors 110. For example, interaction with the electronic entity 106 can be received via various input methods, such as those relying on mice, keyboards, and remote controls, as well as Natural User Interface (NUI) methods, which enable a user to interact with the computing device 102 in a “natural” manner, such as via technologies including touch sensitive displays, voice and speech recognition, intention and goal understanding, motion gesture detection using depth cameras, motion gesture detection using accelerometers/gyroscopes, facial recognition, 3D displays, head, eye, and gaze tracking, immersive augmented reality and virtual reality systems, all of which provide a more natural interface. According to an aspect, the user's interactive response is communicated with the electronic entity mirroring system 108, for example, for analysis and determination of the user's current context.

In some examples, in determining the set of characteristics to apply to the electronic entity 106, the characteristics engine 114 is operative to select characteristics for reactively mirroring the user 104. For example, as described above, mirroring is a behavior in which one entity imitates gestures, speech patterns, or attitudes of another entity that signals to one entity that the other entity is attuned or in sync. By applying mirroring characteristics to the electronic entity 106, the electronic entity 106 is able to increase the user's trust and engagement. For example, continuing with one of the examples above, if the child covers his eyes with his hands in response to the presentation of the electronic entity 106, the characteristics engine 114 may mirror the child's reaction by incrementally changing the electronic entity representation to cover its eyes, and then peek up at the child. The child may responsively connect and engage with the electronic entity 106. According to an aspect, the electronic entity mirroring system 108 continues to collect context data via the one or more sensors 110, and continue to make incremental changes to the electronic entity 106 for increasing the user's engagement, emotional connection, and trust.

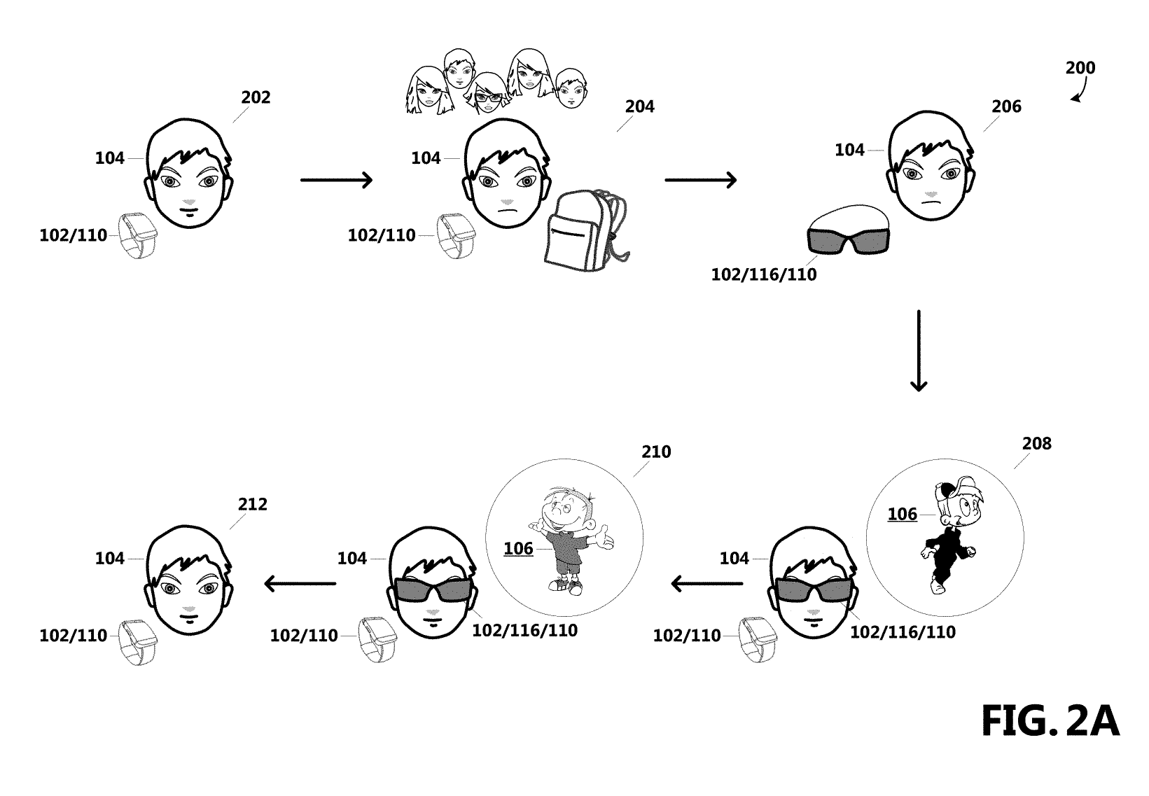

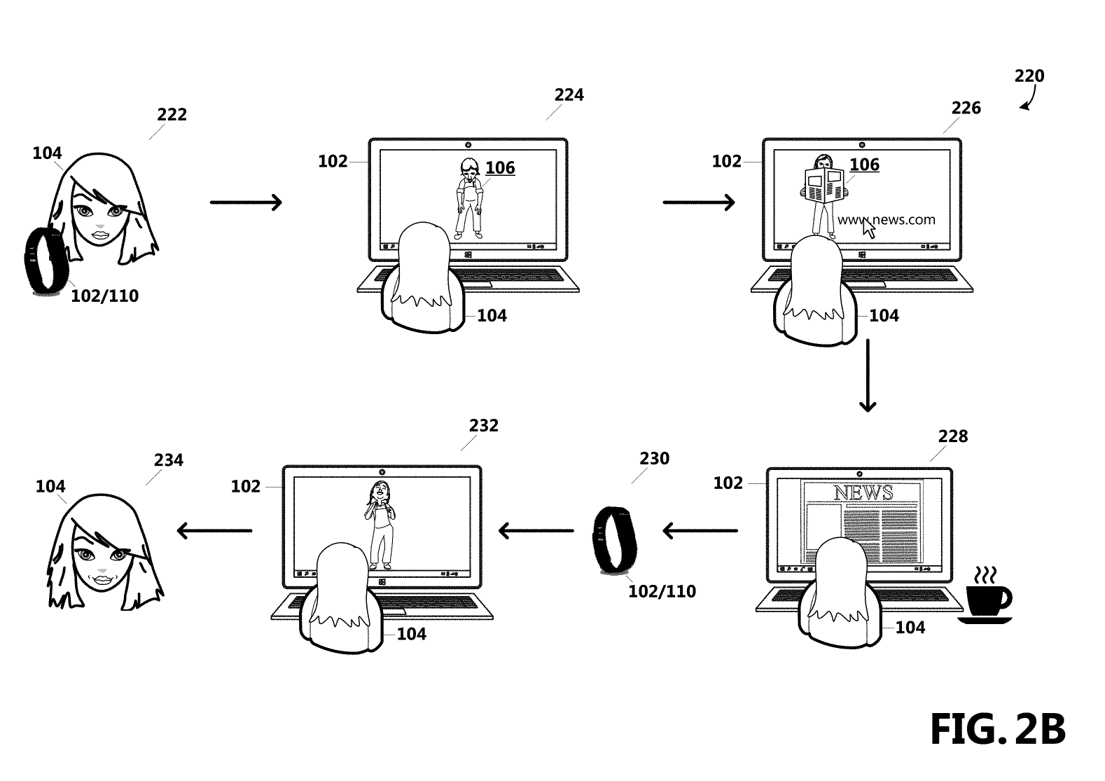

With reference now to FIG. 2A, an example storyboard 200 is illustrated that shows an example use case utilizing aspects of the electronic entity mirroring system 108. The first illustration 202 in the example storyboard 200 shows a user 104 “Jeromy.” Based on explicit and implicit relationship data and pieces of world knowledge data and historical data, various characteristics related to Jeromy are known or inferred. According to the example, Jeromy is a male child who is autistic. For example, his autistic characteristics include: odd behaviors, rituals, and gestures that are apparent to others; angers easily or shows aggression due to daily routine changes; has a fixation with cartoon character “Calvin;” unable to remember names of people or things; and is severely language delayed. Jeromy (user 104) has a wearable device 102 that is equipped with sensors 110 able to capture and deliver information to the electronic entity mirroring system 108.

With reference now to the second illustration 204 in the example storyboard 200, Jeromy goes to school, where the other kids at the school are being very boisterous, thus interrupting Jeromy's regular routine. As is known by the system 108, the disruption in Jeromy's routine can result in a strong physical reaction from him (e.g., a tantrum, aggressive self-injurious behavior). Jeromy's wearable device 102 may detect the noise level and Jeromy's increased heartbeat. In some examples, the device 102 notifies the user 104 or a guardian who can begin a mitigation procedure tailored to the user 104. For example, a teacher may be notified of Jeromy's condition, and the teacher may provide an appropriate computing device 102 to Jeromy.

With reference now to the third illustration 206 in the example storyboard 200, Jeromy is provided a holographic headset computing device 102. For example, the holographic headset computing device 102 may include one or more sensors 110 and is configured to operate as an output device 116 of holographic visual representations and audio.

With reference now to the fourth illustration 208 in the example storyboard 200, aspects of the electronic entity mirroring system 108 know and understand Jeromy's autistic patterns, characteristics, and behaviors (e.g., physically and emotionally), and deliver a mitigation response that helps Jeromy deescalate his heightened state. For example, the system 108 generates a presents a display of an electronic entity 106 embodied as Jeromy's favorite cartoon character “Calvin” that helps Jeromy to focus his attention off of the surrounding distracting activities.

With reference now to the fifth illustration 210 in the example storyboard 200, as Jeromy (user 104) moves through his episode, the system 108 is able to monitor Jeromy's behavior in relation to his known or inferred physical and emotional characteristics. To further increase Jeromy's trust and connection with the “Calvin” augmented electronic entity 106, the system begins to mirror Jeromy. For example, aspects of the electronic entity mirroring system 108 apply proactive characteristics to the electronic entity 106, such as postures and body language that reflect a more calm state. Jeromy reactively begins to mirror the calm characteristics applied to the electronic entity 106, and Jeromy moves to a calmer state.

With reference now to the sixth illustration 212 in the example storyboard 200, Jeromy progresses through his episode without much incident (e.g., no tantrum, injurious behavior to himself or to others), and his context returns to a level within a predetermined normal range.

With reference now to FIG. 2B, an example storyboard 220 is illustrated that shows an example use case utilizing aspects of the electronic entity mirroring system 108. The first illustration 222 in the example storyboard 220 shows a user 104 “Liz.” Based on explicit and implicit relationship data and pieces of world knowledge data and historical data, various characteristics related to Liz are known or inferred. According to the example, Liz is an information worker. She has a normal routine each workday, where she starts her morning drinking a cup of hot tea as she reads an online newspaper. Further, Liz has a wearable device 102 that is equipped with sensors 110 and Liz's computing device 102 is equipped with various sensors able to capture and deliver information to the electronic entity mirroring system 108. For example, based on data acquired by the sensors 110 and on known or inferred characteristics associated with Liz, the electronic entity mirroring system 108 may detect that Liz is drowsy and is not working productively.

With reference now to the second illustration 224 in the example storyboard 220, aspects of the electronic entity mirroring system 108 may understand Liz's normal behavioral patterns and characteristics, and deliver a mitigation response that helps Liz to be more alert and productive. For example, the system 108 generates a presents a display of an electronic entity 106 embodied as an avatar.

With reference now to the third illustration 226 in the example storyboard 220, the system 108 knows Liz's normal pattern of reading the online newspaper each morning and further knows that Liz did not follow her normal routine this morning. The system 108 may apply proactive characteristics to the electronic entity 106 based on Liz's characteristics. For example, the system 108 may generate a display of the electronic entity 106 reading a newspaper. Additionally, other information may be provided, such as a link to the online newspaper that Liz normally reads.

With reference now to the fourth illustration 228 in the example storyboard 220, Liz is reminded that she has skipped her normal routine. She gets a cup of hot tea, and selects the link to the online newspaper. In the fifth illustration 230, Liz's context is detected by one or more sensors 110. She is feeling more alert and is ready to begin a productive workday.

With reference now to the sixth illustration 232, aspects of the electronic entity mirroring system 108 apply additional proactive characteristics to the electronic entity 106, such as postures and body language that reflect a happy state. Liz reactively begins to mirror the postures and body language, and as illustrated in the seventh illustration 234, moves into a more positive and productive state.

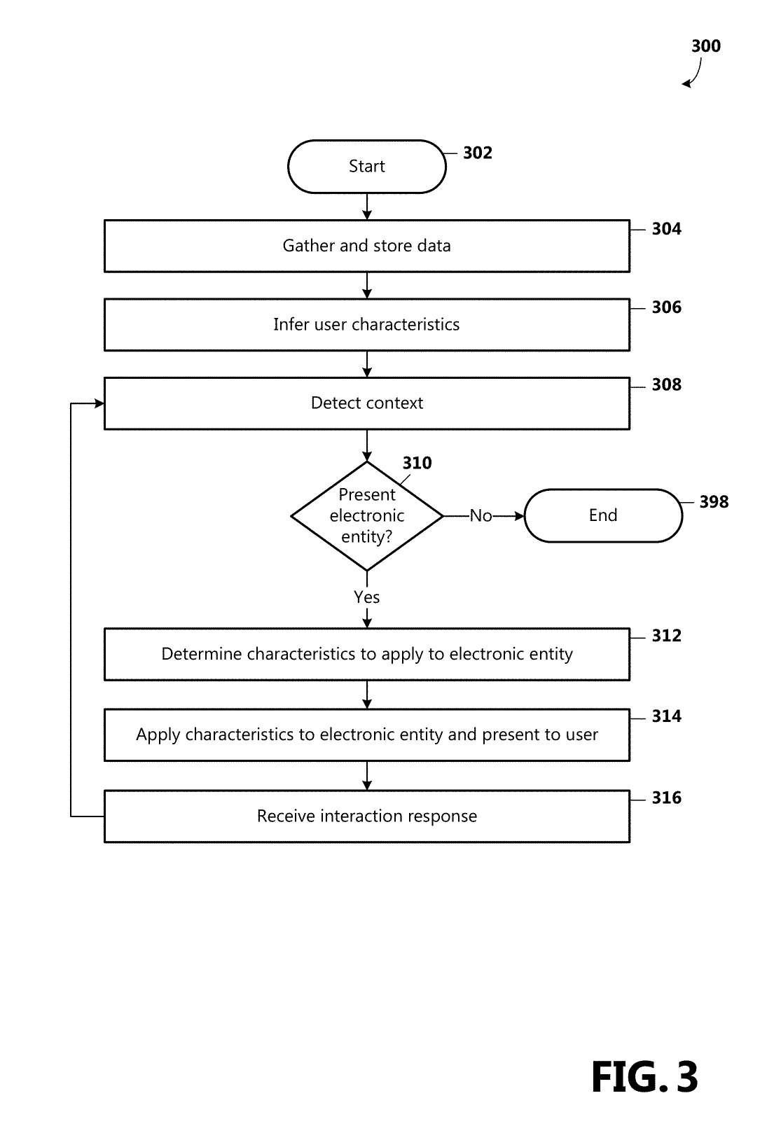

Having described an operating environment with respect to FIG. 1 and example use case scenarios with respect to FIGS. 2A-2B, FIG. 3 is a flow chart showing general stages involved in an example method 300 for generating an electronic entity display that mirrors user-related characteristics based on a user's context. With reference now to FIG. 3, the method 300 begins at start OPERATION 302, and proceeds to OPERATION 304, where information associated with the user 104 is collected and stored in one or more semantic graph databases. For example, information associated with documents that the user 104 creates or receives, organizational relationships, Internet search activities, tasks, communications, use of applications, etc., are collected, and relationships between the user 104 and other entities are defined.

The method 300 proceeds to OPERATION 306, where user characteristics are inferred. For example, alone or in combination with other information, such as historical data (e.g., based on past user interactions with the electronic entity mirroring system 108), world knowledge available via one or more data sources 118, the knowledgebase 120 data are used to infer characteristics associated with the user 104.

The method 300 continues to OPERATION 308, where one or more sensors 110 are used to collect information associated with the user's context (e.g., environmental information, biometric information, activity information). Further, the context data are abstracted and analyzed for understanding the user's context (e.g., environmental physical conditions (e.g., noise level, light level, air quality), an emotive state of the user 104 (e.g., via facial emotion detection, sentiment analysis, eye tracking), biophysiologic abnormalities (e.g., blood pressure, heartrate, temperature), the user's location, the user's activity level).

The method 300 proceeds to DECISION OPERATION 310, where a determination is made as to whether to present an electronic entity 106 to the user 104. In some examples, the determination is based on determining whether the user's context is within or outside of a predetermined normal range. For example, the predetermined normal range can be based at least in part on inferred user-related characteristics, historical data, and world knowledge data.

When a determination is made to present an electronic entity 106, the method 300 proceeds to OPERATION 312, where characteristics to apply to the electronic entity 106 are determined. For example, the characteristics are based in part on the user's context and known or inferred characteristics about the user 104. According to some examples, the context engine 112 provides an alert for notifying the user 104 or another individual when the user's context is outside of a predetermined normal range (e.g., elevated blood pressure, increased heartrate, poor air quality, high noise level). For example, the user 104 or other individual may actuate the characteristics engine 114 for triggering the electronic entity 106. In other examples, the characteristics engine 114 is automatically triggered when the user's context is determined to be outside of a predetermined normal range.

At OPERATION 314, the system 108 generates a UI display including a display of the electronic entity 106 having the selected characteristics, and presents the electronic entity 106 to the user 104 via one or more output devices 116. In some examples, the selected characteristics are applied to the electronic entity 106 for proactively mitigating certain user behaviors or emotive states. The method 300 proceeds to OPTIONAL OPERATION 316, where an interaction response is received from the user 104. For example, the user 104 may mirror characteristics or behaviors applied to and expressed by the electronic entity 106.

The method 300 returns to OPERATION 308, where the user's context is detected, and at DECISION OPERATION 310, another determination is made as to whether to continue presenting the electronic entity 106 or to end the session. For example, the determination may be based on whether the user's context has returned to a predetermined normal state. When a determination is made to no longer present the electronic entity 106, the method 300 ends at OPERATION 398.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 4-6 and the associated descriptions provide a discussion of a variety of operating environments in which examples are practiced. However, the devices and systems illustrated and discussed with respect to FIGS. 4-6 are for purposes of example and illustration and are not limiting of a vast number of computing device configurations that are utilized for practicing aspects, described herein.

FIG. 4 is a block diagram illustrating physical components (i.e., hardware) of a computing device 400 with which examples of the present disclosure may be practiced. In a basic configuration, the computing device 400 includes at least one processing unit 402 and a system memory 404. According to an aspect, depending on the configuration and type of computing device, the system memory 404 comprises, but is not limited to, volatile storage (e.g., random access memory), non-volatile storage (e.g., read-only memory), flash memory, or any combination of such memories. According to an aspect, the system memory 404 includes an operating system 405 and one or more program modules 406 suitable for running software applications 450. According to an aspect, the system memory 404 includes the electronic entity mirroring system 108. The operating system 405, for example, is suitable for controlling the operation of the computing device 400. Furthermore, aspects are practiced in conjunction with a graphics library, other operating systems, or any other application program, and are not limited to any particular application or system. This basic configuration is illustrated in FIG. 4 by those components within a dashed line 408. According to an aspect, the computing device 400 has additional features or functionality. For example, according to an aspect, the computing device 400 includes additional data storage devices (removable and/or non-removable) such as, for example, magnetic disks, optical disks, or tape. Such additional storage is illustrated in FIG. 4 by a removable storage device 409 and a non-removable storage device 410.

As stated above, according to an aspect, a number of program modules and data files are stored in the system memory 404. While executing on the processing unit 402, the program modules 406 (e.g., electronic entity mirroring system 108) perform processes including, but not limited to, one or more of the stages of the method 300 illustrated in FIG. 3. According to an aspect, other program modules are used in accordance with examples and include applications 450 such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 4 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 400 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 400 has one or more input device(s) 412 such as a keyboard, a mouse, a pen, a sound input device, a touch input device, etc. The output device(s) 414 such as a display, speakers, a printer, etc. are also included according to an aspect. The aforementioned devices are examples and others may be used. According to an aspect, the computing device 400 includes one or more communication connections 416 allowing communications with other computing devices 418. Examples of suitable communication connections 416 include, but are not limited to, radio frequency (RF) transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (i.e., memory storage.) According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. According to an aspect, any such computer storage media is part of the computing device 400. Computer storage media does not include a carrier wave or other propagated data signal.

According to an aspect, communication media is embodied by computer readable instructions, data structures, program modules, or other data in a modulated data signal, such as a carrier wave or other transport mechanism, and includes any information delivery media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

FIGS. 5A and 5B illustrate a mobile computing device 500, for example, a mobile telephone, a smart phone, a tablet personal computer, a laptop computer, and the like, with which aspects may be practiced. With reference to FIG. 5A, an example of a mobile computing device 500 for implementing the aspects is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. According to an aspect, the display 505 of the mobile computing device 500 functions as an input device (e.g., a touch screen display). If included, an optional side input element 515 allows further user input. According to an aspect, the side input element 515 is a rotary switch, a button, or any other type of manual input element. In alternative examples, mobile computing device 500 incorporates more or less input elements. For example, the display 505 may not be a touch screen in some examples. In alternative examples, the mobile computing device 500 is a portable phone system, such as a cellular phone. According to an aspect, the mobile computing device 500 includes an optional keypad 535. According to an aspect, the optional keypad 535 is a physical keypad. According to another aspect, the optional keypad 535 is a “soft” keypad generated on the touch screen display. In various aspects, the output elements include the display 505 for showing a graphical user interface (GUI), a visual indicator 520 (e.g., a light emitting diode), and/or an audio transducer 525 (e.g., a speaker). In some examples, the mobile computing device 500 incorporates a vibration transducer for providing the user with tactile feedback. In yet another example, the mobile computing device 500 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 500 incorporates peripheral device port 540, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one example of a mobile computing device. That is, the mobile computing device 500 incorporates a system (i.e., an architecture) 502 to implement some examples. In one example, the system 502 is implemented as a “smart phone” capable of running one or more applications (e.g., browser, e-mail, calendaring, contact managers, messaging clients, games, and media clients/players). In some examples, the system 502 is integrated as a computing device, such as an integrated personal digital assistant (PDA) and wireless phone.

According to an aspect, one or more application programs 550 are loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. According to an aspect, the electronic entity mirroring system 108 is loaded into memory 562. The system 502 also includes a non-volatile storage area 568 within the memory 562. The non-volatile storage area 568 is used to store persistent information that should not be lost if the system 502 is powered down. The application programs 550 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500.

According to an aspect, the system 502 has a power supply 570, which is implemented as one or more batteries. According to an aspect, the power supply 570 further includes an external power source, such as an AC adapter or a powered docking cradle that supplements or recharges the batteries.

According to an aspect, the system 502 includes a radio 572 that performs the function of transmitting and receiving radio frequency communications. The radio 572 facilitates wireless connectivity between the system 502 and the “outside world,” via a communications carrier or service provider. Transmissions to and from the radio 572 are conducted under control of the operating system 564. In other words, communications received by the radio 572 may be disseminated to the application programs 550 via the operating system 564, and vice versa.

According to an aspect, the visual indicator 520 is used to provide visual notifications and/or an audio interface 574 is used for producing audible notifications via the audio transducer 525. In the illustrated example, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. According to an aspect, the system 502 further includes a video interface 576 that enables an operation of an on-board camera 530 to record still images, video stream, and the like.

According to an aspect, a mobile computing device 500 implementing the system 502 has additional features or functionality. For example, the mobile computing device 500 includes additional data storage devices (removable and/or non-removable) such as, magnetic disks, optical disks, or tape. Such additional storage is illustrated in FIG. 5B by the non-volatile storage area 568.

According to an aspect, data/information generated or captured by the mobile computing device 500 and stored via the system 502 is stored locally on the mobile computing device 500, as described above. According to another aspect, the data is stored on any number of storage media that is accessible by the device via the radio 572 or via a wired connection between the mobile computing device 500 and a separate computing device associated with the mobile computing device 500, for example, a server computer in a distributed computing network, such as the Internet. As should be appreciated such data/information is accessible via the mobile computing device 500 via the radio 572 or via a distributed computing network. Similarly, according to an aspect, such data/information is readily transferred between computing devices for storage and use according to well-known data/information transfer and storage means, including electronic mail and collaborative data/information sharing systems.

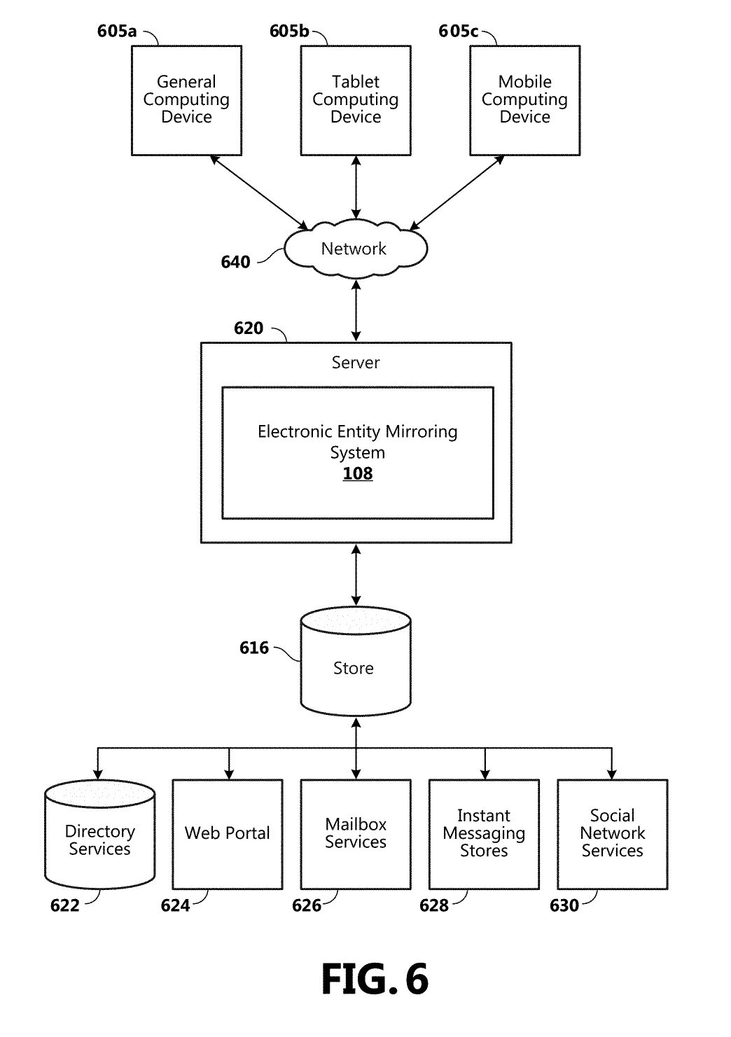

FIG. 6 illustrates one example of the architecture of a system for generating an electronic entity display that mirrors user-related characteristics based on a user's context as described above. Content developed, interacted with, or edited in association with the electronic entity mirroring system 108 is enabled to be stored in different communication channels or other storage types. For example, various documents may be stored using a directory service 622, a web portal 624, a mailbox service 626, an instant messaging store 628, or a social networking site 630. The electronic entity mirroring system 108 is operative to use any of these types of systems or the like for generating an electronic entity display that mirrors user-related characteristics based on a user's context, as described herein. According to an aspect, a server 620 provides the electronic entity mirroring system 108 to clients 605a,b,c. As one example, the server 620 is a web server providing the electronic entity mirroring system 108 over the web. The server 620 provides the electronic entity mirroring system 108 over the web to clients 605 through a network 640. By way of example, the client computing device is implemented and embodied in a personal computer 605a, a tablet computing device 605b or a mobile computing device 605c (e.g., a smart phone), or other computing device. Any of these examples of the client computing device are operable to obtain content from the store 616.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A computer-implemented method for generating an electronic entity display that mirrors user-related characteristics based on a user's context comprising:
inferring user-related characteristics;
detecting the user's context;
determining user-related characteristics to apply to an electronic entity display;
applying the user-related characteristics to the electronic entity display; and
presenting the electronic entity display having the user-related characteristics to the user.

2. The method of claim 1, wherein inferring user-related characteristics comprises inferring user-related characteristics based at least in part on one or a combination of:
knowledgebase data;
historical data; and
world knowledge available via one or more data sources.

3. The method of claim 2, wherein inferring user-related characteristics based at least in part on knowledgebase data comprises inferring user-related characteristics based on explicit and implicit relationships defined in one or more semantic graph databases.

4. The method of claim 1, wherein detecting the user's context comprises:
receiving context data acquired by one or more sensors;
abstracting the context data; and
matching a perceived sensory stimulus to a context.

5. The method of claim 1, wherein detecting the user's context comprises detecting at least one of:
environmental physical conditions;
an emotive state of the user;
biophysiologic abnormalities;
the user's location; and
the user's activities.

6. The method of claim 1, wherein presenting the electronic entity display comprises generating a graphical display of an image for presentation on a display screen.

7. The method of claim 1, wherein presenting the electronic entity display comprises generating a graphical display of a holographic image for presentation on a virtual screen.

8. The method of claim 1, further comprising incrementally updating the electronic entity display based at least in part on a responsive interaction by the user.

9. The method of claim 1, wherein determining user-related characteristics to apply to the electronic entity display comprises determining user-related characteristics to apply to the electronic entity display to proactively mitigate certain user behaviors.

10. The method of claim 1, wherein determining user-related characteristics to apply to the electronic entity display comprises determining user-related characteristics to apply to the electronic entity display to reactively redirect certain behaviors.

11. A system for generating an electronic entity display that mirrors user-related characteristics based on a user's context, the system comprising:
at least one processing device; and
at least one computer readable data storage device storing instructions that, when executed by the at least one processing device, cause the system to:
infer user-related characteristics;
detect the user's context;
determine user-related characteristics to apply to an electronic entity display;
apply the user-related characteristics to the electronic entity display; and
present the electronic entity display having the user-related characteristics to the user.

12. The system of claim 11, wherein the system is further operative to incrementally update the electronic entity display based at least in part on a responsive interaction by the user.

13. The system of claim 11, wherein in detecting the user's context, the system is operative to:
receive context data acquired by one or more sensors;
abstract the context data; and
detect at least one of:
environmental physical conditions;
an emotive state of the user;
biophysiologic abnormalities;
the user's location; and
the user's activities.

14. The system of claim 11, wherein in presenting the electronic entity display, the system is operative to generate a graphical display of an image for presentation on a display screen.

15. The system of claim 11, wherein in presenting the electronic entity display, the system is operative to generate a graphical display of a holographic image for presentation on a virtual screen.

16. The system of claim 11, wherein in inferring user-related characteristics, the system is operative to infer user-related characteristics based at least in part on one or a combination of:
knowledgebase data;
historical data; and
world knowledge available via one or more data sources.

17. The system of claim 16, wherein in wherein in inferring user-related characteristics based at least in part on knowledgebase data, the system is operative to infer user-related characteristics based on explicit and implicit relationships defined in one or more semantic graph databases.

18. A computer readable storage device including computer readable instructions, which when executed by a processing unit is operative to:
infer user-related characteristics based at least in part on one or a combination of:
knowledgebase data;
historical data; and
world knowledge available via one or more data sources;
detect the user's context;
determine user-related characteristics to apply to an electronic entity display;
apply the user-related characteristics to the electronic entity display; and
present the electronic entity display having the user-related characteristics to the user.

19. The computer readable storage device of claim 18, wherein in detecting the user's context, the device is operative to:
receive context data acquired by one or more sensors;
abstract the context data; and
detect at least one of:
environmental physical conditions;
an emotive state of the user;
biophysiologic abnormalities;
the user's location; and
the user's activities.

20. The computer readable storage device of claim 18, wherein in presenting the electronic entity display, the system is operative to:
generate a graphical display of an image for presentation on a display screen; or
generate a graphical display of a holographic image for presentation on a virtual screen.
